(19) United States
(12) Patent Application Publication
(10) Pub. No.: US 2026/0052226 A1
(43) Pub. Date: Feb. 19, 2026

(54) MULTI-DEVICE USER EXPERIENCE FOR VIRTUAL MEETINGS

(71) Applicant: Google LLC, Mountain View, CA (US)

(72) Inventor: Yadrian Serrano Garcia, Cary, NC (US)

(21) Appl. No.: 18/806,362

(22) Filed: Aug. 15, 2024

(51) Int. Cl. H04N 7/15

(52) U.S. Cl. CPC H04N 7/157; H04N 7/152

(57) ABSTRACT

Systems and methods for providing a multi-device user experience for virtual meetings. A user device participating in a virtual meeting is identified. The user device is associated with a user account of a user. A user interface of the virtual meeting includes a visual item representing the user. A virtual meeting configuration associated with the user account is identified. Based on the virtual meeting configuration associated with the user account, one or more additional user devices associated with the user account are identified. The user is allowed to join the virtual meeting via at least one of the one or more additional user devices associated with the user account, within adding an additional visual item to the user interface of the virtual meeting.

### TECHNICAL FIELD

Aspects and implementations of the present disclosure relate to providing a multi-device user experience for virtual meetings.

### BACKGROUND

Virtual meetings can take place between multiple participants via a virtual meeting platform. A virtual meeting platform can enable users to connect with other users through a video or an audio-based virtual meeting (e.g., a conference call, or a virtual meeting). The virtual meeting platform can provide tools that allow multiple client devices to connect over a network and share each other's audio data (e.g., a voice of a user recorded via a microphone of a client device) and/or video data (e.g., a video captured by a camera of a client device, or video captured from a screen image of the client device) for efficient communication. To this end, the virtual meeting platform can provide a user interface that includes multiple regions to present the audio and/or video streams of each participating client device. For example, the virtual meeting platform can display video from each client device in a separate box (commonly referred to as a tile) in the user interface.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed for providing a multi-device user experience for virtual meetings. In an implementation, a method includes identifying a user device participating in a virtual meeting. The user device is associated with a user account of a user. A user interface of the virtual meeting includes a visual item representing the user. The method includes identifying a virtual meeting configuration associated with the user account. The method includes identifying, based on the virtual meeting configuration associated with the user account, one or more additional user devices associated with the user account. The method includes allowing the user to join the virtual meeting via at least one of the one or more additional user devices associated with the user account without adding an additional visual item to the user interface of the virtual meeting.

In some implementations, the method further includes identifying a set of characteristics for each of a plurality of user devices associated with the user account. The plurality of user devices can include the user device and the one or more additional user devices. The method further includes identifying, based on the sets of characteristics, a plurality of virtual meeting configurations.

In some implementations, the method further includes providing, for presentation on the user device, the plurality of virtual meeting configurations associated with the user account; and receiving, from the user device, an indication of the virtual meeting configuration associated with the user account.

In some implementations, identifying, based on the sets of characteristics, the plurality of virtual meeting configurations associated with the user account includes providing, as input to a trained artificial intelligence (AI) model, the sets of characteristics, and receiving, as output from the trained AI model, the plurality of virtual meeting configurations and a score associated with each of the plurality of virtual meeting configurations, wherein the score reflects a confidence level of the corresponding virtual meeting configuration.

In some implementations, wherein identifying the virtual meeting configuration associated with the user account comprises identifying a user preference associated with the user account, wherein the user preference identifies the virtual meeting configuration comprising the user device and the at least one of the one or more additional user devices associated with the user account.

In some implementations, the virtual meeting configuration comprises at least one of: a three-dimensional visual configuration, a three-dimensional audio configuration, or a 360-degree representation of the user generated using AI based on the visual input form the user device and at least two additional user devices.

In some implementations, the virtual meeting configuration comprises associating each of the user device and the one or more additional user devices with one or more functions of a plurality of functions. The plurality of functions comprises at least displaying at least one of a subset of a plurality of participants of the virtual meeting, displaying a shared screen of the virtual meeting, displaying a currently speaking participant of the virtual meeting, a camera function, a microphone function, or a speaker device function.

In some implementations, the method includes identifying a speaker device associated with each of the user device and the one or more additional user devices. The method includes identifying a display location of a corresponding visual item of each participant of at least a subset of the participants of the virtual meeting. The method includes assigning a first participant of the at least the subset of the participants to a first speaker of the speaker devices based on the display location of the first participant.

An aspect of the disclosure provides a system including a memory device and a processing device communicatively coupled to the memory device. The processing device performs the method as described above.

An aspect of the disclosure provides a computer-readable storage medium (which can be a non-transitory computer-readable storage medium, although the disclosure is not limited to that) stores instructions which, when executed, cause a processing device to perform the method as described above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with at least one embodiment of the present disclosure.

FIG. 2 is a block diagram illustrating an example virtual meeting manager system, in accordance with at least one embodiment of the present disclosure.

FIG. 3 illustrates example device configuration for a particular user participating in a virtual meeting, in accordance with at least one embodiment of the present disclosure.

FIG. 4 is a flow diagram of an example method for establishing a virtual meeting configuration for a user to join a virtual meeting from multiple devices as a single participant, in accordance with at least one embodiment of the present disclosure.

FIG. 5 is a flow diagram of an example method for implementing a virtual meeting configuration to enable a user to join a virtual meeting as a single participant via multiple user devices associated, in accordance with at least one embodiment of the present disclosure.

FIG. 6A illustrates a schematic block diagram for an artificial intelligence (AI) training subsystem of a virtual meeting platform, in accordance with at least one embodiment of the present disclosure.

FIG. 6B illustrates a schematic block diagram for an AI inference subsystem of a virtual meeting platform, in accordance with at least one embodiment of the present disclosure.

FIG. 7 is a block diagram illustrating an exemplary computer system, in accordance with at least one embodiment of the present disclosure.

### DETAILED DESCRIPTION

Aspects of the present disclosure relate to providing a multi-device user experience for virtual meetings. A virtual meeting refers to a real-time communication session, such as a virtual meeting call, also known as a video-based call or video chat, in which participants can connect with multiple additional participants, via a virtual meeting platform, in real-time and be provided with audio and video capabilities. The virtual meeting platform can enable video-based virtual meetings between multiple participants via client devices that are connected over a network and share each other's audio (e.g., voice of a user recorded via a microphone of a client device) and/or video streams (e.g., a video captured by a camera of a client device) during a virtual meeting. The image data can, in some instances, depict a user or a group of users that are participating in the virtual meeting. The audio data can include, in some instances, an audio recording of audio provided by the user or group of users during the virtual meeting. Some existing virtual meeting platforms can provide a user interface (UI) to each client device connected to the virtual meeting, where the UI displays visual items (e.g., tiles) corresponding to the video streams shared over the network in a set of regions in the UI. A visual item can refer to a UI element that occupies a particular region in a UI.

Some conventional virtual meeting platforms display video and/or audio received from each client device as a separate participant in the virtual meeting. For example, a conventional virtual meeting platform can display a visual item for each client device that participates in the virtual meeting. Thus, if a user joins a virtual meeting from multiple devices, the user is counted as multiple participants in the virtual meeting, and is displayed using multiple visual items in the UI, one visual item for each of the multiple devices. A participant may want to join a virtual meeting from multiple devices, such as their mobile phone, computer, and/or tablet device, for a variety of reasons. For example, a user may want to participate in the virtual meeting using the microphone from their headset connected to their mobile phone and the camera that is connected to their computer, and thus may choose to participate in the virtual meeting via both devices. Conventional virtual meeting platforms may display the user as two participants in the meeting, even though the user is joining from the same user account.

Platforms that display each client device as a separate participant can dissuade users from joining a virtual meeting from multiple devices. Consequently, users may not utilize the devices at their disposal in an optimal or desired manner. Using a single client device to participate in a virtual meeting when multiple client devices are available can result in a misuse of valuable computing resources. For example, one of the user's client devices may have resources that can efficiently display the video feeds from the other participants in the virtual meeting, another one of the user's client devices may have (or be connected to) a good quality microphone to pick up the user's voice, and yet another one of the user's client devices may have (or be connected to) a good quality speaker to output the audio from the other participants. If a user joins a virtual meeting on a conventional platform from each client device, the platform can use computing resources to collect and display audio and video for each client device as a different participant in the virtual meeting, resulting in unnecessary consumption of compute resources. As a result, treating each client device as a separate participant decreases the overall efficiency and increases overall latency of the virtual meeting platform. Additionally, treating each client device as a separate participant results in each client displaying the entire virtual meeting interface, which can result in an inefficient use of space on a client device.

Aspects of the present disclosure address the above-noted and other deficiencies by providing a unified multi-device feature for a virtual meeting of a virtual meeting platform, in which a user can join the virtual meeting from multiple client devices as a single participant. A client device can be a personal computer (optionally connected to multiple monitors), a laptop, a mobile phone, a smartphone, a tablet computer, a netbook computer, a network-connected television, etc. The multi-device feature can enable a user to join a virtual meeting as a single participant from multiple client devices associated with the user (e.g., the user can be logged in to the same user account on each user device). By joining the virtual meeting as a single participant, the virtual meeting platform can display a single visual item (e.g., a single tile in the UI) to represent the user, even if the user joins the virtual meeting via multiple client devices.

In some embodiments, a user can provide input to establish a virtual meeting configuration for joining virtual meetings on a virtual meeting platform. A virtual meeting configuration (or simply “configuration”) refers to a customizable configuration of multiple client devices to join or participate in a virtual meeting as a single participant. The virtual meeting configuration can be used to provide instructions that indicate which client device(s) are to perform which function(s) during the virtual meeting. For example, a virtual meeting configuration can identify a first client device to perform the display functions, a second client device to perform the audio input function (e.g., to function as the microphone), a third client device to perform the visual input function (e.g., to function as the camera), and a combination of the three client devices to perform as the audio output function (e.g., to function as the speaker device). Note that multiple client devices can perform multiple functions. The user can provide input for the virtual meeting configuration prior to joining a virtual meeting. The particular configuration can be based on, for example, a user preference, a user selection, characteristics of the client devices, and/or a combination thereof. In some embodiments, virtual meeting configurations depend on a number of factors, such as the number of client devices available, the characteristics of the devices available (e.g., the specifications and/or status of each device's CPU, GPU, speaker, microphone, camera, etc.), the size of the virtual meeting (e.g., how many participants have joined the virtual meeting, or how many participants are expected to join (e.g., invited to) the virtual meeting), whether the user is designated as a leader of the virtual meeting (e.g., whether the user has scheduled the meeting, or whether the user is identified as an organizer of the meeting), and/or other factors. The virtual meeting configurations can correspond to a user account of the user of the virtual meeting platform.

In some embodiments, the multi-device feature component can identify the client devices that are associated with a user. For example, the user can be logged into an account (e.g., an account associated with the virtual meeting platform) on multiple client devices, and the multi-device feature can identify on which client devices the user is logged into the account. The multi-device feature can generate and/or provide device configuration options to the user. In some embodiments, the multi-device feature can provide the configuration options in response to a triggering event. The triggering event can be, for example, receiving a notification that the user is logged into the same account on multiple devices, or receiving an instruction to provide configuration options (e.g., the instruction can be from a user selection on a user interface). In some embodiments, the configuration options can be default configuration options for the number of client devices associated with the user. In some embodiments, the configuration options can be based on user preferences and/or settings associated with the user account, and/or based on client device characteristics of the client devices associated with the user. The multi-device feature can implement one of the configuration options, e.g., in response to receiving a selection from the user.

In some embodiments, a multi-device feature component of a virtual meeting platform can identify a user device that is participating in a virtual meeting. The user device can be associated with a user account of a user. The user account can correspond to the virtual meeting platform, for example, and the user can be logged into their user account on multiple devices. The multi-device feature component can identify a particular virtual meeting configuration for the user account for the virtual meeting. In some embodiments, the multi-device feature component can identify multiple virtual meeting configurations for the user account. The particular configuration can be based on a user preference, a user selection, characteristics of the client devices, and/or a combination thereof. In some embodiments, the user preference can be a setting previously set by the user, prior to the current virtual meeting. In some embodiments, multiple configuration options can be presented to the user via a UI of one of the client devices, and the user can select a particular configuration for the user account. In some embodiments, the multiple configuration options can take into consideration the characteristics of the client devices. Characteristics can include, for example, the specifications and/or status of the each device's CPU, GPU, speaker, microphone, camera, etc.

Based on the identified virtual meeting configuration of the user account, the multi-device feature component can identify additional client devices that are associated with the user account (e.g., on which the user account is logged in). The multi-device feature component can then allow the user to join the virtual meeting from the multiple client devices as a single participant, without adding an additional visual item to the user interface of the virtual meeting.

In some embodiments, the multi-device feature can be implemented using an artificial intelligence model to identify a virtual meeting configuration for the client devices. The virtual meeting configuration can include, for example, instructions to use one or more of the client devices as a speaker device, use one or more client devices as a microphone, and/or use one or more of the client devices as a camera. The virtual meeting configuration can also include instructions to identify on which client device(s) to display which participant(s) of the virtual meeting and/or on which client device(s) to display a shared screen or whiteboard. In some embodiments, the virtual meeting configuration can be dynamic, and can include a three-dimensional visual configuration, a three-dimensional audio configuration, and/or a 360-degree representation of the user. As an illustrative example, a dynamic virtual meeting configuration can indicate (e.g., provide instructions) to use the speaker device for the client device on which a particular participant is displayed to output the audio of that particular participant when they are speaking. For example, the participants can be split among two monitors and a tablet device. When a participant that is displayed on the tablet device speaks, the dynamic configuration can indicate that the speaker device of the tablet device should be used to output the audio of that participant. When a participant that is displayed on the second monitor speaks, the dynamic configuration can indicate that the speaker of the second monitor should be used to output the audio of that participant. In some embodiments, this dynamic configuration can enable the speaker device of two client devices to output audio of two different participants simultaneously.

In some embodiments, the dynamic virtual meeting configuration can indicate that the direction the user is looking at should be identified, and the camera of the client device that the user is looking at should be used to collect and transmit the video feed. That way, the user is consistently displayed to the other participants as looking directly at the camera. In some embodiments, the dynamic configuration can indicate that the microphone that is closest to the user should be identified and used to collect and transmit audio of the user speaking. In some embodiments, the dynamic configuration can indicate that the microphone from each client device should be used, and a single audio stream should be outputted. In some embodiments, the dynamic configuration can indicate that the microphone from all client devices should be used, and multiple audio streams should be outputted, each audio stream correlated to the microphone that collected the audio data. For example, the user can have four client devices, each one collecting audio data via a corresponding connected microphone. Another participant in the virtual meeting can have enabled four speaker devices, and each speaker device can output one of the four audio streams collected from one of the user's microphones.

In some embodiments, the multi-device feature component can implement an artificial intelligence model to identify a camera device to use as the video input source for the user. In some embodiments, the multi-device feature component can implement an artificial intelligence model to identify and/or select a microphone to use as the audio input source for the user. In some embodiments, the multi-device feature component can implement an artificial intelligence model to generate a 360-degree view of the user, using video feeds from three or more client devices of the user.

Aspects of the present disclosure provide a number of technical advantages over previous solutions including, for example, providing additional functionality to a virtual meeting platform to enable a user to join a virtual meeting from multiple devices as a single participant, represented by a single visual item in the UI (e.g., without adding visual items in the UI of the virtual meeting for each device). Such functionality can result in more efficient use of processing resources utilized to facilitate the virtual meeting. That is, the virtual meeting platform can implement a virtual meeting configuration for the user account, in which certain devices are used for certain functions. For example, the virtual meeting configuration can include instructions to assign one of the devices to be used as an audio input source. As a result, the virtual meeting platform may not need to use audio input sources of the user's other devices participating in the virtual meeting, thus avoiding the unnecessary use of those audio input resources. Additionally, the virtual meeting platform may not expend resources on filtering through audio from multiple input sources. The same reasoning can be applied to video input sources of the user's multiple client devices participating in the virtual meeting. Furthermore, displaying a single visual item for each participant rather than for each client device that participates in a virtual meeting results in more efficient use of space on client devices, which can be especially beneficial for small-screen client devices such as mobile phones and laptops, for example. As an illustrative example, if 100 participants each join a virtual meeting from three client devices, aspects of the present disclosure enable the UI to display 100 visual items (one for each participant), rather 300 visual items (one for each client device) for the virtual meeting.

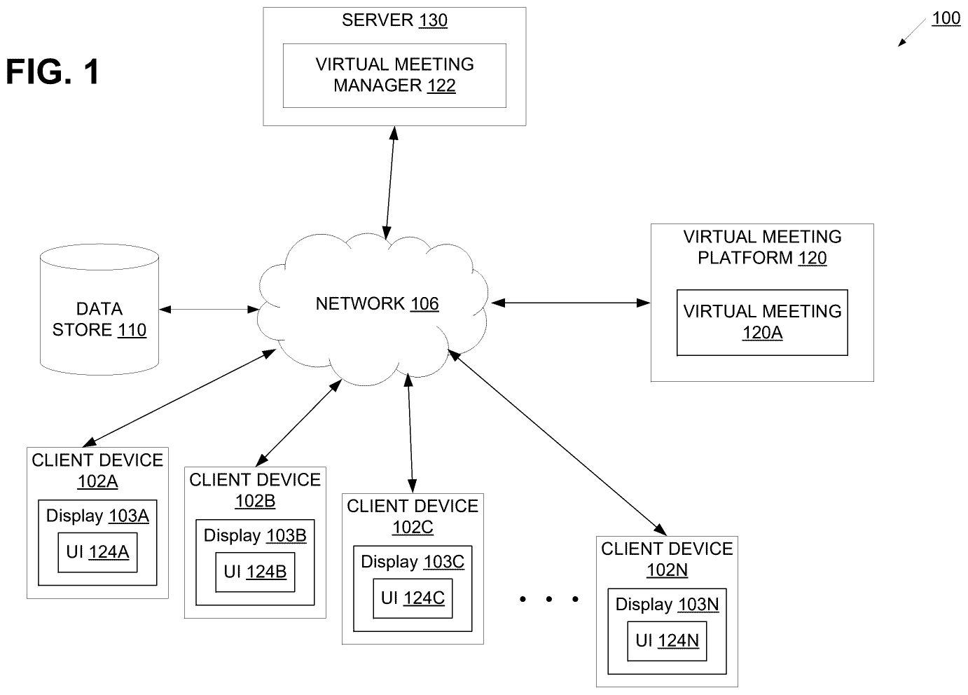

FIG. 1 illustrates an example system architecture 100, in accordance with at least one embodiment of the present disclosure. The system architecture 100 (also referred to as “system” herein) includes client devices 102A-N, a data store 110, a virtual meeting platform 120, and/or a server 130, each connected to a network 106. In some implementations, network 106 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. A data item can include audio data and/or video stream data, in accordance with embodiments described herein. Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that can be hosted by virtual meeting platform 120 or one or more different machines (e.g., the server 130) coupled to the virtual meeting platform 120 via network 106. In some implementations, the data store 110 can store device settings and virtual meeting configurations for the virtual meeting platform 120. Moreover, the data store 110 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-N and/or concurrently editable by the users.

In some embodiments, the virtual meeting platform 120 can enable users of client devices 102A-N to connect with each other via a virtual meeting (e.g., a virtual meeting 120A). A virtual meeting refers to a real-time communication session, such as a virtual meeting call, also known as a video-based call or video chat, in which participants can connect with multiple additional participants in real-time and be provided with audio and video capabilities. Real-time communication refers to the ability for users to communicate (e.g., exchange information) instantly without transmission delays and/or with negligible (e.g., milliseconds or microseconds) latency. The virtual meeting platform 120 can allow a user to join and participate in a virtual meeting with other users of the platform. Embodiments of the present disclosure can be implemented with any number of participants connecting via the virtual meeting (e.g., from two participants up to one hundred or more).

The client devices 102A-N can each include computing devices such as personal computers (PCs), laptops, mobile phones, smartphones, tablet computers, netbook computers, network-connected televisions, etc. In some implementations, client devices 102A-N can also be referred to as “user devices.” Each client device 102A-N can include an audiovisual component that can generate audio and video data to be streamed to virtual meeting platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component can also include an image capture device (e.g., a camera) to capture images and generate video data (e.g., a video stream) of the captured data of the captured images.

In some embodiments, one or more of client devices 102A-N can be associated with a physical conference or meeting room. Such client device(s) can include, or be coupled to, a media system that can include display device(s), speaker(s), and/or camera(s). A display device can be, for example, a smart display or a non-smart display (e.g., a display that is not itself configured to connect to network 106). Users that are physically present in the room can use the media system rather than their own devices (e.g., client devices 102A-N) to participate in a virtual meeting, which can include other remote users.

Each client device 102A-N can include a web browser and/or a client application (e.g., a mobile application, a desktop application, etc.). In some implementations, the web browser and/or the client application can present, on a display device 103A-103N of client device 102A-N, a user interface (UI) (e.g., a UI of the UIs 124A-N) for users to access virtual meeting platform 120. For example, a user of client device 102A can join and participate in a virtual meeting 120A via a UI 124A presented on the display device 103A by the web browser or client application. A user can also present a document to participants of the virtual meeting via each of the UIs 124A-N. Each of the UIs 124A-N can include multiple regions to present visual items corresponding to video streams of other users participating in the virtual meeting 120A.

In some embodiments, server 130 can include a virtual meeting manager 122. Virtual meeting manager 122 can be configured to manage a virtual meeting between multiple users of virtual meeting platform 120. In some implementations, virtual meeting manager 122 can provide the UIs 124A-N to each client device to enable users to watch and listen to each other during a virtual meeting. Virtual meeting manager 122 can also collect and provide data associated with the virtual meeting to each participant of the virtual meeting. In some implementations, virtual meeting manager 122 can provide the UIs 124A-N for presentation by a client application (e.g., a mobile application, a desktop application, etc.). For example, the UIs 124A-N can be displayed on a display device 103A-103N by a native application executing on the operating system of the client device 102A-N. The native application can be separate from a web browser.

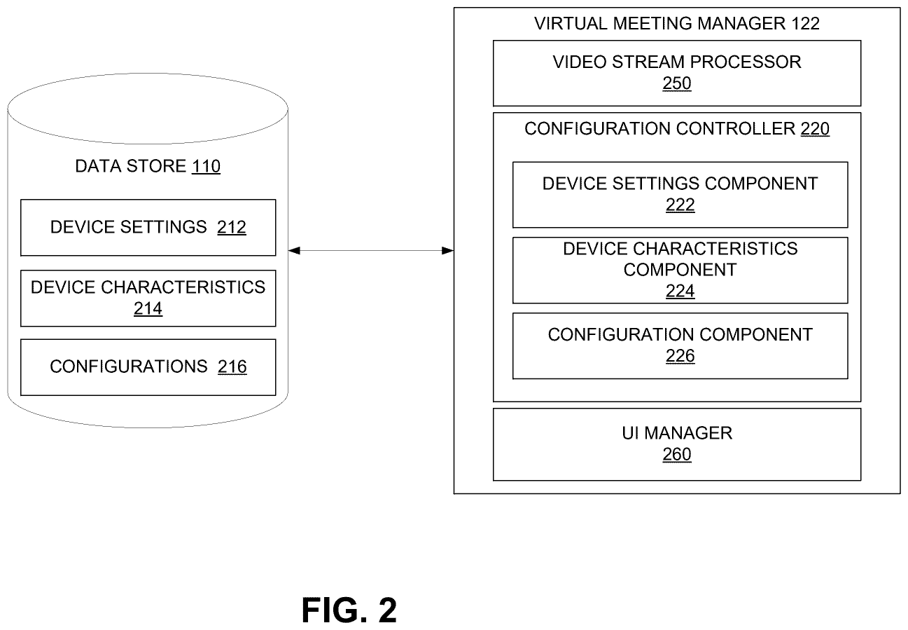

In some embodiments, the virtual meeting manager 122 can determine visual items for presentation in the UIs 124A-N during a virtual meeting 120A. A visual item can refer to a UI element that occupies a particular region in the UI 124A-N. A visual item can correspond to a particular user participating in the virtual meeting 120A. The visual item can present a video stream of a corresponding user, generated according to a virtual meeting configuration associated with the user account. The visual item can depict, for example, a user of one or more client devices 120A-N while the user is participating in the virtual meeting 120A (e.g., speaking, presenting, listening to other participants, watching other participants, etc., at particular moments during the virtual meeting 120A), a physical conference or meeting room (e.g., with one or more participants present), a document or media (e.g., video content, one or more images, etc.) being present during the virtual meeting 120A, etc. The virtual meeting manager 122 is further described with respect to FIG. 2.

An audiovisual component of each client device can capture images and generate video data (e.g., a video stream) of the captured data of the captured images. In some implementations, the client devices 102A-N can transmit the generated video stream to server 130. The audiovisual component of each client device can also capture an audio signal representing speech of a user and generate audio data (e.g., an audio file or audio stream) based on the captured audio signal. In some implementations, the client devices 102A-N can transmit the generated audio data to server 130. In some embodiments, a virtual meeting configuration can indicate from which client device(s) 102A-N the virtual meeting manager 122 receives video data and/or from which client device(s) 102A-N the virtual meeting manager 122 receives audio data for a particular user account.

In some embodiments, a subset of client devices 102A-N can be associated with a particular user participating in the virtual meeting 120A. For example, a particular user can be logged into a user account associated with the platform 120 on more than one client device 102A-N. As an illustrative example, a particular user can be logged into a user account on client devices 102A-C. As an illustrative example, client device 102A can be the particular user's laptop, client device 120B can be the particular user's smartphone, and client device 102C can be the particular user's tablet device. Each client device 102A-C can be capable of participating in virtual meeting 120A on behalf of the particular user.

In some embodiments, the client devices 102A-N participating in the virtual meeting can transmit video streams (including audio data) to server 130. The server 130 can execute a virtual meeting manager 122 that can identify and/or implement a virtual meeting configuration for each user participating in the virtual meeting 120A.

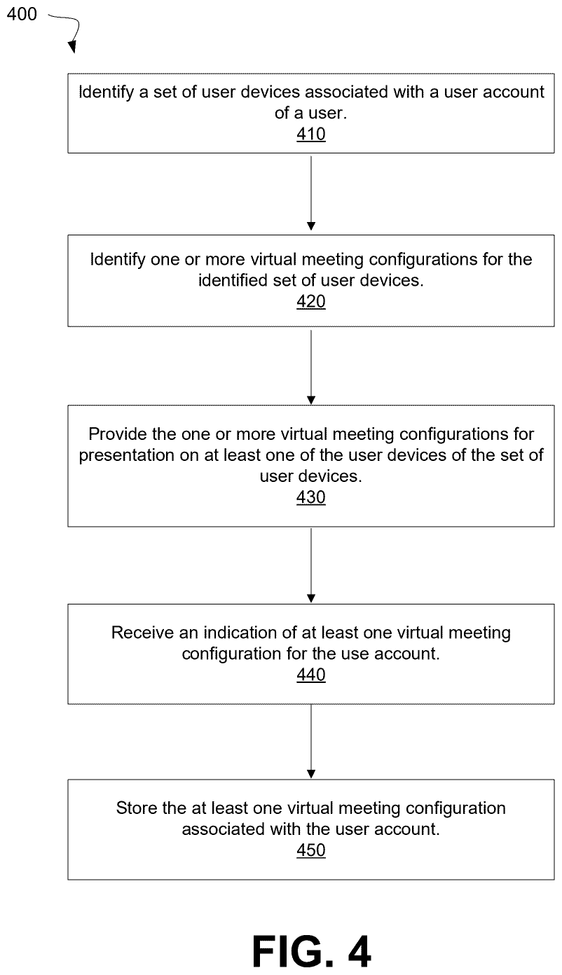

In some embodiments, a user can provide input for one or more virtual meeting configurations for their user account. For example, a user can configure user settings for participating in virtual meetings on the virtual meeting platform 120 prior to joining a virtual meeting 120A. Establishing a virtual meeting configuration is further described with respect to FIG. 4. Virtual meeting manager 122 can then identify a particular virtual meeting configuration for the user account, and can configure the corresponding client devices 102A-N according to the identified virtual meeting configuration. The virtual meeting manager 122 is further described with respect to FIG. 2.

It should be noted that in some other implementations, the functions of server 130 or virtual meeting platform 120 can be provided by a fewer number of machines. For example, in some implementations, server 130 can be integrated into a single machine, while in other implementations, server 130 can be integrated into multiple machines. In addition, in some implementations, server 130 can be integrated into virtual meeting platform 120.

In general, functions described in implementations as being performed by virtual meeting platform 120 or server 130 can also be performed by the client devices 102A-N in other implementations, if appropriate. In addition, the functionality attributed to a particular component can be performed by different or multiple components operating together. Virtual meeting platform 120 and/or server 130 can also be accessed as a service provided to other systems or devices through appropriate application programming interfaces, and thus is not limited to use in websites.

Although implementations of the disclosure are discussed in terms of virtual meeting platform 120 and users of virtual meeting platform 120 participating in a virtual meeting, implementations can also be generally applied to any type of telephone call or conference call between users. Implementations of the disclosure are not limited to virtual meeting platforms that provide virtual meeting tools to users.

In implementations of the disclosure, a “user” or “participant” can be represented as a single individual. However, other implementations of the disclosure encompass a “user” being an entity controlled by a set of users or an organization and/or an automated source such as a system or a platform. In situations in which the system discussed here collects personal information about users, or can make use of personal information, the users can be provided with an opportunity to control whether server device 130 and/or platform 120 collects user information (e.g., personal information about the user, information about a user's location, a user's preferences, and/or any other personal information), or to control whether and/or how to receive content from the server device 130 that can be more relevant to the user. In addition, certain data can be treated in one or more ways before it is stored or used, so that personally identifiable information is removed. Thus, the user can have control over how information is collected about the user and used by server device 130, platform 120, and/or user device 102A-N.

FIG. 2 is a block diagram illustrating an example virtual meeting manager system 200, in accordance with at least one embodiment of the present disclosure. The virtual meeting manager system 200 can include a virtual meeting manager 122 and one or more data stores 100. The virtual meeting manager 122 can access the data store 110, e.g., via a network 106 of FIG. 1. The virtual meeting manager 122 can be a software program hosted by a device (e.g., server device 130, platform 120) to enable a user to participate in a virtual meeting from multiple client devices as a single participant. The virtual meeting manager 122 and/or data store 110 can be the same as, or perform the same functions as, virtual meeting manager 122 and data store 110 of FIG. 1, respectively. The virtual meeting manager 122 can include a video stream processor 250, a configuration controller 220, and a user interface (UI) manager 260. Each of the video stream processor 250, the configuration controller 220, and/or the UI manager 260 can include a software application (or a subset thereof) that performs certain virtual meeting functionality for the virtual meeting manager 122. The video stream processor 250, the configuration controller 220, and/or the UI manager 260 can be combined together or separated into further components, according to a particular implementation. It should be noted that in some implementations, various components of the virtual meeting manager 122 can run on separate machines. In embodiments, each of the components can be or include logic configured to perform a particular action or set of actions. In embodiments, one or more of the components can be combined into a single component. In embodiments, the functions of one or more components can be divided into sub-components.

In some embodiments, data store 110 can store device settings 212, device characteristics 214, and/or configurations 216 for the virtual meeting platform 120. In some embodiments, device settings 212, device characteristics 214, and/or configurations 216 can each store a separate data structure associated with a respective virtual meeting (e.g., virtual meeting 120A). In some embodiments, each device settings 212, device characteristics 214, and/or configuration 216 data structure can be populated with participant identifiers for the participants of the corresponding virtual meeting, and corresponding device identifiers. In some embodiments, device settings 212, device characteristics 214, and/or configurations 216 can be stored on a server, such as server 130, and processed by virtual meeting manager 122. In some embodiments, device settings 212, device characteristics 214, and/or configurations 216 can be stored on one or more associated client devices 102A-N. It is appreciated that the functionality of device settings 212, device characteristics 214, and/or configurations 216 can be implemented using a variety of data structures. For example, device settings 212, device characteristics 214, and/or configurations 216 can be implemented as a list, an array, a vector, a set, a linked list, a stack, a queue, a buffer, a tree, a graph, and the like.

In some embodiments, device settings 212 data can refer to settings that the user of the device (e.g., the participant) has previously established. Device settings 212 can include, for example, an identification of which audio input device(s) is to be used for a particular virtual meeting configuration, an identification of which visual input device(s) is to be used for a particular virtual meeting configuration, an identification of which display device(s) is to be used for a particular virtual meeting configuration (and optionally an instruction on what to display on which display device), an identification of which audio output device(s) is to be used for a particular virtual meeting configuration, etc. In some embodiments, a user can provide input to establish one or more particular virtual meeting configurations as described with respect to FIG. 4. As an illustrative example, a user can be logged into their user account on three client devices 120A-C, and can have provided input to establish device settings for multiple virtual meeting configurations. For one such particular virtual meeting configuration, a user can provide input to establish the following device settings to be stored in device settings 212: display the currently-speaking participant on a first device (e.g., client device 102A), display any shared documents on a second device (e.g., client device 102B), display the other participants on a third device (e.g., client device 102C), use a combination of all three device microphones as the audio input source, use the speaker connected to client device 102B as the audio output source, and use the camera that the user is currently facing as the visual input source (e.g., using a camera identification process as described with respect to configuration component 226). As another example, the user can provide input to establish the following device settings to be stored in device setting 212: use client device 102A (e.g., the user's laptop computer) as the display device, use client device 102B (e.g., the user's phone) as the audio input and output device (e.g., the user may have connected his headphones to his phone, and may want to avoid un-connecting and reconnecting his headphones when joining a virtual meeting), and use the client device 102C (e.g., the user's tablet) as the visual input device (e.g., the user may have a good quality camera connected to their tablet that they prefer to user for meetings). A user can provide input to establish device settings 212 for multiple virtual meeting configurations. In some embodiments, the virtual meeting configurations can depend on which client devices are associated with the user at the time of the virtual meeting (e.g., which client devices the user has logged in to), the number of participants in the virtual meeting (e.g., for virtual meetings with more than 50 participants, the user can identify a virtual meeting configuration that includes instructions to display the participants on multiple client devices and to display the currently-speaking participant on a separate client device, whereas for virtual meetings with less than 10 participants, the user can identify a virtual meeting configuration that includes instructions to display the participants on a single client device UI and does not identify a separate client device to display the currently speaking participant), and so on. It should be noted that these are merely illustrative examples.

In some embodiments, device characteristics 214 data can refer to characteristics of each client device 102A-N. Example device characteristic can include specifications of a corresponding device (e.g., CPU processing power, CPU resource availability, GPU processing power, GPU resource availability, specifications of the speakers of (or connected to) the device, of the camera of (or connected to) the device, of the microphone of (or connected to) the device, of the display device (e.g., size of the display panel), etc.), the status of the device (e.g., whether the camera is turned on, whether the microphone is functioning, etc.).

In some embodiments, configurations 216 data can refer to stored virtual meeting configurations for a user account. A virtual meeting configuration can identify one or more client device(s) and the function of each client device. The configurations 216 can store virtual meeting configurations as provided by a user (e.g., as described with respect to FIG. 4), and/or as generated by configuration component 226. In some embodiments, a virtual meeting configuration stored in configurations 216 can be a dynamic configuration that provides instructions according to configuration component 226. For example, a dynamic virtual meeting configuration can include instructions to use the camera that the participant is facing as the visual input source, in which case the configuration component 226 can implement a camera identification process to identify the camera that the user is facing during the virtual meeting 120A. As another example, a dynamic virtual meeting configuration can include instructions to use the microphone that the participant is closest to as the audio input source, in which case the configuration component 226 can implement a microphone identification process to identify the microphone that the user is closest (e.g., identified as the microphone that to produces the clearest recording) during the virtual meeting 120A. As another example, the dynamic virtual meeting configuration can include instructions to generate a 360-degree visual of the user using the three cameras facing the participant, in which case the configuration component 226 can implement an AI model to generate a 360-degree view of the user during the virtual meeting 120A.

In some embodiments, the video stream processor 250 can be configured to receive video and/or audio streams from one or more of the client devices 102A-N. The video stream processor 250 can process and/or configure the video and/or audio streams to produce video and/or audio data that can be analyzed by configuration component 220.

In some embodiments, configuration controller 220 can be configured to identify a virtual meeting configuration for a participant of a virtual meeting (e.g., virtual meeting 120A). In some embodiments, configuration controller 220 can include a device settings component 222, a device characteristics component 224, and/or a configuration component 226.

In some embodiments, device settings component 222 can identify device settings of client devices 102A-N associated with a particular user for a virtual meeting 120A. In some embodiments, device settings component 222 can identify which client device(s) 102A-N are associated with a particular user (e.g., participant) of a virtual meeting 120A. That is, device settings component 222 can identify on which client device(s) 102A-N the particular user is logged into. In some embodiments, the device settings component 222 can identify the settings of those devices as stored in device settings 212.

In some embodiments, device characteristics component 224 can identify device characteristics of client devices 102A-N associated with a particular user for a virtual meeting 120A. In some embodiments, device characteristics component 224 can identify which client device(s) 102A-N are associated with a particular user (e.g., participant) of a virtual meeting 120A. That is, device characteristics component 224 can identify on which client device(s) 102A-N the particular user is logged into. In some embodiments, the device characteristics component 224 can identify the settings of those devices as stored in device characteristics 214. In some embodiments, the device characteristics component 224 can query a client device 102A-N to identify the characteristics for that particular device, and can store the identified characteristics in device characteristics 214.

In some embodiments, configuration component 226 can identify and/or generate virtual meeting configurations for a particular user account. The configuration component 226 can identify a user device (e.g., client device 102A) participating in a virtual meeting (e.g., virtual meeting 120A). The configuration component 226 can identify a user account that the user of client device 102A is logged into. The configuration component 226 can identify a virtual meeting configuration stored in configuration 216 associated with the particular user account. For example, the user can have provided input to establish a preferred virtual meeting configuration (e.g., as described with respect to FIG. 4), and the configuration component 226 can identify the user's preferred virtual meeting configuration (e.g., the preferred virtual meeting configuration associated with the user's user account). The configuration component 226 can then identify the client device(s) 102A-N that are identified in the user's preferred virtual meeting configuration. The configuration component 226 can identify one or more additional user device(s) (e.g., client devices 102B-N) that are associated with the user account. That is, the configuration component 226 can identify which devices of the client devices identified in the stored virtual meeting configuration are logged into the user account. The configuration component 226 can enable the user to join the virtual meeting 120A using the client device 102A and the additional identified client devices 102B-N, according to the virtual meeting configuration, as a single participant. The configuration component 226 can send an instruction to UI manager 260 to generate the UI using a single visual item to represent that user, and to generate the visual item according to the virtual meeting configuration.

In some embodiments, the configuration component 226 can identify and/or generate virtual meeting configurations for a particular user account participating in a virtual meeting 120A. In some embodiments, the configuration component 226 can compare the device settings 212 and/or the device characteristics 214 associated with client device(s) 102A-N associated with the user to stored configurations 216 associated with the user's user account, and can identify a virtual meeting configuration that matches (or satisfies) the device settings 212 and/or device characteristics 214. In some embodiments, the configuration component 226 can cause the identified virtual meeting configurations to be displayed on the UI of the user device participating in the virtual meeting 120A (e.g., client device 102A), and the configuration component 226 can identify a selection from the user of the user device. That is, the configuration component 226 can enable the user can select one of multiple possible virtual meeting configurations that match (or satisfy) the device settings 212 and/or the device characteristics 214 of the device(s) associated with the user participating in the virtual meeting. The configuration component 226 can then instruct the UI manager 260 to implement the identified or selected virtual meeting configuration.

In some embodiments, configuration component 226 can implement one or more AI models to identify and/or generate a virtual meeting configuration for a particular participant of the meeting. Configuration component 226 can provide the device settings 212 and/or device characteristics 214 for the client devices 102A-N associated with a particular user as input to a trained AI model. The AI model can output one or more virtual meeting configurations for the user account. Each virtual meeting configuration output by the AI model can have a corresponding score that reflects a confidence level of the corresponding virtual meeting configuration. The configuration component 226 can rank the virtual meeting configurations output by the AI model by confidence level score, and can identify the virtual meeting configuration with the highest confidence level score as the virtual meeting configuration for the virtual meeting. In some embodiments, the configuration component 226 can cause the virtual meeting configurations output by the AI model (e.g., displayed in order of confidence level score) to be displayed in a UI of the user's client device, and can enable the user to select one of the virtual meeting configurations. The configuration component 226 can instruct the UI manager 260 to implement the identified and/or selected virtual meeting configuration.

In some embodiments, configuration component 226 can train and/or use a trained AI model to identify one or more visual input devices (e.g., a cameras) of multiple devices of a participant to include in the virtual meeting configuration. In some embodiments, configuration component 226 can provide, as input to a trained AI model, video feeds received from client devices associated with a particular user. The AI model can output an indication of which of the video feeds to use to generate the visual item for the user during the virtual meeting. In some embodiments, the configuration component 226 can assign the visual input device from which the identified video feed is received as the visual input device for the virtual meeting configuration. In some embodiments, the AI model can be trained to output an indication of the video feed that has the highest quality. In some embodiments, the AI model can be trained to output an indication of the video feed that displays the user facing the camera. In some embodiments, the configuration component 226 can run the trained AI model once (e.g., at the beginning of the virtual meeting, or when the participant joins the virtual meeting) to identify the video feed to use in generating the visual item representing the participant. In some embodiments, the configuration component 226 can run the trained AI model repeatedly (e.g., on a predetermined schedule, once every 2 minutes) to identify the video feed to use in generating the visual item representing the participant. That way, the visual item can be updated to include the video that best represents the participant at different points in time during the virtual meeting.

In some embodiments, configuration component 226 can train and/or use a trained AI model to identify one or more audio input devices (e.g., microphones) of multiple devices of a participant to include in the virtual meeting configuration. In some embodiments, the configuration component 226 can provide, as input to the trained AI model, audio feeds (or video feeds that include audio) received from client devices associated with a particular user. The AI model can output an indication of which of the audio feeds (or video feeds that include audio) to generate the visual item for the user during the virtual meeting. In some embodiments, the configuration component 226 can assign the audio input device from which the identified audio feed (or video feed) is received as the audio input device for the virtual meeting configuration. In some embodiments, the AI model can be trained to output an indication of the audio feed that has the highest quality. In some embodiments, the AI model can be trained to output an indication of the audio feed that displays the user is closest to (e.g., the audio feed that has the strongest input). In some embodiments, the configuration component 226 can run the trained AI model once (e.g., at the beginning of the virtual meeting, or when the participant joins the virtual meeting) to identify the audio feed to use in generating the visual item representing the participant. In some embodiments, the configuration component 226 can run the trained AI model repeatedly (e.g., on a predetermined schedule, once every 2 minutes) to identify the audio feed to use in generating the visual item representing the participant. That way, the visual item can be updated to include the audio that best represents the participant at different points in time during the virtual meeting.

In some embodiments, configuration component 226 can train and/or use a trained AI model to identify one or more audio output devices (e.g., speakers) of multiple devices of a participant to include in a virtual meeting configuration. In some embodiments, the configuration component 226 can provide, as input the trained AI model, device settings 212 and/or device characteristics 214 of the devices associated with the user account of the participant participating in the virtual meeting. The trained AI model can provide, as output, an indication of which audio output device(s) should be used during the virtual meeting. In some embodiments, the configuration component 226 can provide, as additional input to a trained AI model, the audio feed received from the other participants participating in the virtual meeting. The AI model can generate an audio output that combines the audio feeds of the other participants into a three-dimensional audio experience, which can be provided using the audio output devices associated with the user account.

In some embodiments, configuration component 226 can train and/or use a trained AI model to generate a 360-degree view of the participant to include in the virtual meeting configuration. The configuration component 226 can provide, as input to the trained AI model, the video feeds from at least three client devices associated with the user account of the participant. The trained AI model can generate a 360-degree view of the participant. The configuration component 226 can instruct the UI manager 260 to use the AI-generated 360-degree view of the participant in the visual item representing the participant.

In some embodiments, UI manager 260 can provide a UI according to the instructions included in the identified virtual meeting configuration for each participant of the virtual meeting 120A. In some embodiments, the UI manager 260 can identify the visual items for the participants of a virtual meeting 120A, and provide the UI for the virtual meeting 120A to the client devices 102A-N for presentation in UI 124A-N, respectively. In some embodiments, the UI manager 260 can provide the visual items based on current speaker, current presenter, order of the participants joining the virtual meeting 120A, list of participants (e.g., alphabetical), etc. In some embodiments, the UI can include multiple regions. A region can display a video stream pertaining to one or more participants of the virtual meeting 120A, according to the instructions included in the identified virtual meeting configuration.

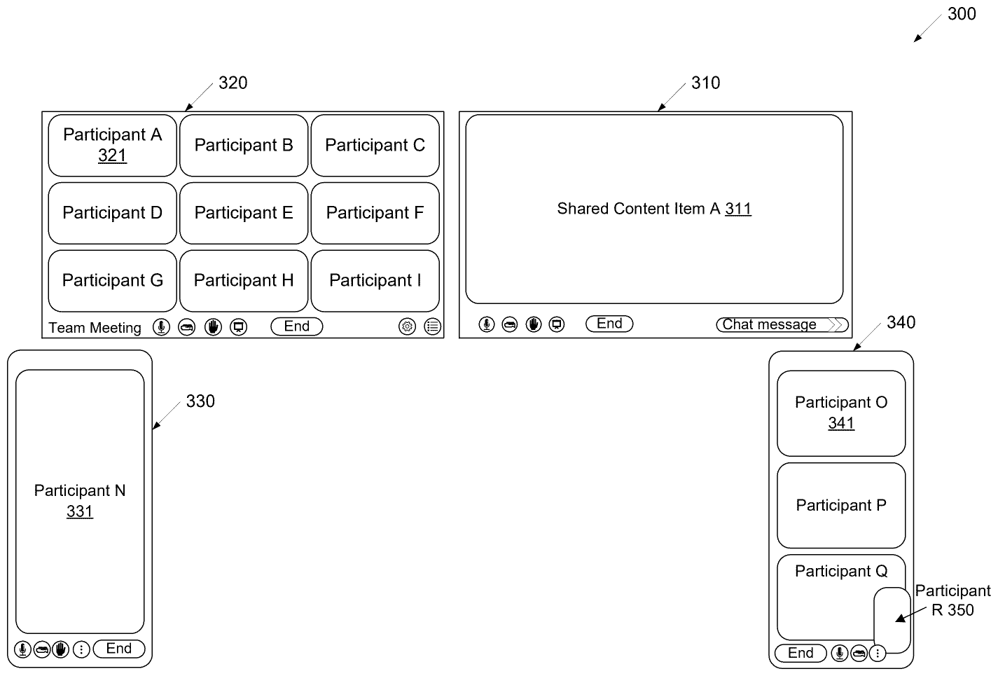

FIG. 3 illustrates an example device configuration 300 for a particular user participating in a virtual meeting, in accordance with at least one embodiment of the present disclosure. The example device configuration 300 can indicate multiple client devices 310, 320, 330, 340 participating in a virtual meeting. Client devices 310-340 can correspond to client devices 120A-N of FIG. 1. Each device 310-340 can include a UI, e.g., generated by the virtual meeting manager 122 of FIGS. 1,2. In some embodiments, the UIs can be generated by one or more processing devices of server 130 and/or of platform 120 of FIG. 1.

Client devices 310-340 can correspond to a single user. As an illustrative example, client device 310 can be a first monitor, client device 320 can be a second monitor, client device 330 can be a smartphone, and client device 340 can be a tablet. The user can be logged into the same user account on each client device 310-340.

In some embodiments, the user can provide input to establish device configuration 300 prior to joining a virtual meeting 120A on virtual meeting platform 120 (e.g., as described with respect to FIG. 4). Upon joining a virtual meeting 120A from a client device (e.g., client device 310), the virtual meeting manager 122 can automatically implement the virtual meeting configuration associated with the user account of the user of the client device (e.g., client device 310). In some embodiments, upon joining a virtual meeting 120A from a client device 310, the virtual meeting manager 122 can identify additional client devices on which the user has logged into their user account. In this illustrative example, the virtual meeting manager can identify client devices 320, 330, and 340 as additional client devices on which the user has logged into the user account. Virtual meeting manager 122 can identify a virtual meeting configuration that incorporates client devices 310-340. Virtual meeting manager 122 can implement virtual meeting configuration, thus allowing the user to participate in the virtual meeting 120A from client devices 310, 320, 330, and 340 without adding an additional visual item to represent the user.

The virtual meeting configuration can provide instructions that indicate on which device(s) 310-340 to display which participant(s), which device(s) 310-340 to use as the audio input source, which device(s) to use as the audio output source, and/or which device(s) to use as that visual input source (e.g., camera). As an illustrative example, the virtual meeting configuration can provide instructions that identify client device 330 to display the currently speaking participant, Participant N 331. Thus, as the currently speaking participant changes, the UI of client device 330 also changes to display the currently speaking participant. The virtual meeting configuration can provide instructions that identify client device 310 to display shared content items, and thus the UI of client device 310 can display Shared Content Item A 311. The virtual meeting configuration can provide instructions that identify the other client devices 320, 340 to display the rest of the participants. In some embodiments, the virtual meeting configuration can include an instruction to split the participant(s) among the UIs of the client devices 320, 340 in such a way to make each visual item representing a participant of approximately the same size.

In some embodiments, the virtual meeting configuration can provide instructions that identify which client device(s) 310-340 should be used as an audio output source (e.g., speaker). In some embodiments, the virtual meeting configuration can be a dynamic configuration that includes an instruction to use the client device on which the speaking-participant is displayed as the audio output source. For example, when participant O 341 is speaking, the virtual meeting manager 122 can use the speaker of client device 340 to output the audio of participant O 341. As another example, when participant A 321 is speaking, the virtual meeting manager 122 can use the speaker of client device 320 to output the audio of participant A 321. As another example, if both Participant A 321 and Participant O 341 are speaking simultaneously, the virtual meeting manager 122 can use the speaker of client device 320 to output the audio of Participant A 321 and the speaker of client device 340 to output the audio of Participant O 341 simultaneously. This feature can mimic being in the same room as the participants, even when they speak at the same time.

In some embodiments, the virtual meeting configuration can include instructions that identify a single client device 310-340 that should be used as the visual input (e.g., camera). In other embodiments, the virtual meeting configuration can be a dynamic configuration, and can include instructions that indicate that the camera of the client device 310-340 that the user is facing should be used as the visual input source. In some embodiments, the virtual meeting manager 122 can implement an AI model that identifies the camera of the client device 310-340 that the user is facing, and the virtual meeting manager 122 can use the video feed from the camera identified by the AI model to represent the user in the visual item corresponding to the user.

In some embodiments, the virtual meeting configuration can include instructions that identify a single client device 310-340 that should be used as the audio input source (e.g., microphone). In other embodiments, the virtual meeting configuration can be a dynamic configuration, and can include instructions that indicate that the microphone of the client device 310-340 that the user is closest to and/or facing should be used as the audio input source. In some embodiments, the virtual meeting manager 122 can implement an AI model that identifies the microphone of the client device 310-340 that the user is closest to, that the user is facing, and/or that is providing the clearest audio input, and the virtual meeting manager 122 can use the audio feed from the microphone identified by the AI model. In some embodiments, the virtual meeting configuration can include instructions to combine the audio from all the microphones of client devices 310-340, and/or from a subset of client devices 310-340, to generate a single audio stream for the user.

In some embodiments, the virtual meeting configuration can include instructions to generate a 360-degree AI generated representation of the user. For example, the virtual meeting configuration can include instructions to provide the video feed from at least three of the client devices 310-340 to an AI model that is trained to output a generated 360-degree view of the participant participating in the virtual meeting 120A.

The virtual meeting manager 122 can generate a visual item for the user, and can provide the visual item to the other participants in the virtual meeting 120A. In the example illustrated in FIG. 3, visual item 350 can represent the user associated with client devices 310-340 (e.g., participant R). The visual item 350 can be generated according to the virtual meeting configuration identified by virtual meeting manager 122 for the user. Thus, the user participant R 350 can participate in the virtual meeting 120A using all four client devices 310-340, and can be represented in the UI of the virtual meeting 120A in a single visual item 350. As another example, participant B can be participating in the virtual meeting 120A from multiple client devices (not pictured), and is represented in the virtual meeting 120A as a single participant.

FIG. 4 is a flow diagram of an example method 400 for establishing a virtual meeting configuration for a user to join a virtual meeting from multiple devices as a single participant, according to at least one embodiment. Method 400 can be performed by processing logic that can include hardware (circuitry, dedicated logic, etc.), software (e.g., instructions run on a processing device), or a combination thereof. In at least one implementation, some or all of the operations of method 400 can be performed by one or more components of server devices 130 of FIG. 1. In other implementations, some or all of the operations of method 400 can be performed by one or more components of client devices 102A-N, and/or virtual meeting platform 120 of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states, e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-related device or storage media.

In some embodiments, method 400 can be performed before a user joins a virtual meeting. For example, method 400 can be performed the first time the user accesses virtual meeting platform 120, and/or can be performed when the user schedules a virtual meeting on virtual meeting platform 120. In some embodiments, method 400 can be performed in response to receiving an instruction to establish a virtual meeting configuration for a user account. For example, the virtual meeting platform 120 can provide a visual item in the UI 124A-N of a client device 120A-N requesting the user to provide input to establish a virtual meeting configuration, and method 400 can be performed in response to the user interacting with the visual item (e.g., by clicking on the visual item). In some embodiments, method 400 can be performed during a virtual meeting 120A.

At block 410, processing logic identifies a set of user devices (e.g., client devices 120A-N) associated with a user account of a user. Processing logic can identify each user device on which the user has logged into an account associated with the virtual meeting platform 120. For example, the virtual meeting platform 120 can be part of an organization that provides multiple platforms and functionalities. A user can have a user account for the organization, which enables the user to access the organization's multiple platforms and functionalities. Thus, the processing logic can identify on which user device the user is logged into the user account of the organization.

At block 420, processing logic identifies one or more virtual meeting configurations for the identified set of user devices. In some embodiments, processing logic can identify user settings and/or preferences to identify the one or more virtual meeting configurations for the identified set of user devices. In some embodiments, processing logic can identify characteristics of each user device in the set of user devices to identify the one or more virtual meeting configurations for the identified set of user devices. In some embodiments, processing logic can use or implement an AI model to identify the one or more virtual meeting configurations for the identified set of user devices.

At block 430, processing logic presents the one or more virtual meeting configurations for presentation on at least one of the user devices of the set of user devices. At block 440, processing logic receives an indication of at least one virtual meeting configuration for the user account. That is, the user can identify at least one of the virtual meeting configurations to use when the user is logged into the set of user devices (and, optionally, a subset of the set of user devices). The user can identify multiple virtual meeting configurations, and can rank the virtual meeting configurations in order of preference. Thus, if the top-choice virtual meeting configuration cannot be implemented, the virtual meeting manager can implement the second-choice virtual meeting configuration. Reasons that a virtual meeting configuration may not be implemented include, for example, an error with one of the user devices in the set of user devices, a malfunctioning piece of hardware or software of the user devices in the set of user devices, a user device resource has reached maximum capacity (e.g., implementing the top-choice virtual meeting configuration can exceed the available capacity of one of the user device's CPU or GPU), a user preference setting that overrides the top-choice virtual meeting configuration (e.g., the user has manually turned off the camera of a particular user device of the set of user devices), etc.

At block 450, processing logic stores the at least one virtual meeting configuration associated with the user account, e.g., in data store 110. When the user joins a virtual meeting 120A, the processing logic can access the at least one virtual meeting configuration associated with the user account, and can enable the user to join the virtual meeting 120A based on that virtual meeting configuration.

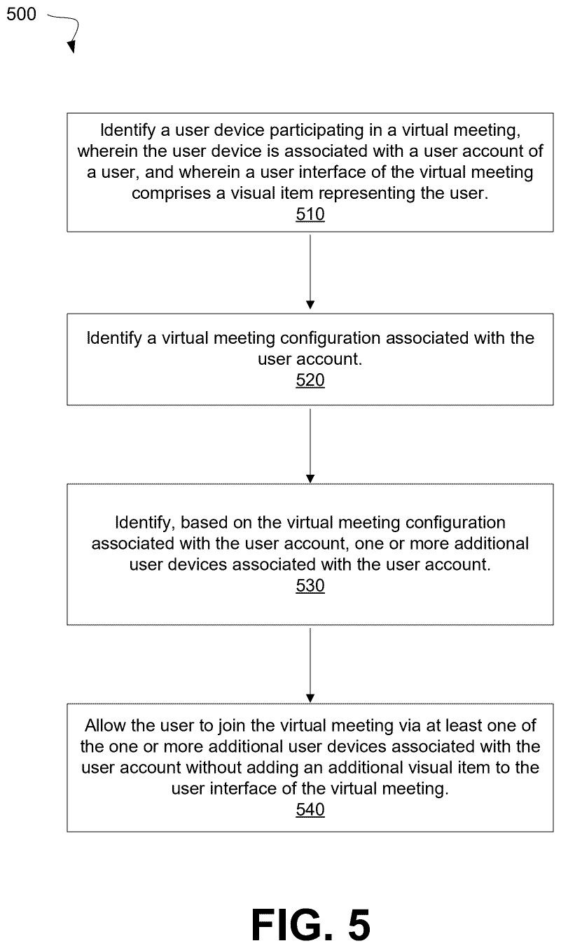

FIG. 5 is a flow diagram of an example method 500 for implementing a virtual meeting configuration to enable a user to join a virtual meeting as a single participant via multiple user devices associated, according to at least one embodiment. Method 500 can be performed by processing logic that can include hardware (circuitry, dedicated logic, etc.), software (e.g., instructions run on a processing device), or a combination thereof. In at least one implementation, some or all of the operations of method 500 can be performed by one or more components of server devices 130 of FIG. 1. In other implementations, some or all of the operations of method 500 can be performed by one or more components of client devices 102A-N, and/or virtual meeting platform 120 of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states, e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-related device or storage media.

At block 510, processing logic identifies a user device participating in a virtual meeting, wherein the user device is associated with a user account of a user, and wherein a user interface of the virtual meeting comprises a visual item representing the user. As an illustrative example, processing logic can identify user device 102A of FIG. 1 participating in a virtual meeting 120A.

At block 520, processing logic identifies a virtual meeting configuration associated with the user account. In some embodiments, the user can have previously provided input to establish a virtual meeting configuration associated with the user account, e.g., as described with respect to FIG. 4.

In some embodiments, the virtual meeting configuration can include instructions to implement at least one of a three-dimensional visual configuration, a three-dimensional audio configuration, and/or a 360-degree representation of the user generated using AI based on visual input from the user device and at least two additional user devices.

In some embodiments, processing logic can implement a 3D audio configuration for the virtual meeting by using the audio output sources (e.g., speakers) of the user device and the one or more additional user devices to simulate the perception of sounds coming from various directions and distances around the user. The 3D audio configuration can mimic how the user would hear the audio of the meeting if the user was in the same room as the other virtual meeting participants. In some embodiments, processing logic can implement a 3D visual configuration for the virtual meeting. Implementing the 3D visual configuration can create the illusion of depth using virtual reality, augmented reality, holography, depth sensing and light field displays, and/or 3D computer graphics (e.g., graphics that are displayed on 2D screens but rendered in a way that simulated depth and perspective). In some embodiments, the 3D visual configuration can be generated by a trained AI model, as further described herein. In some embodiments, a trained AI model can generate a 360-degree view of the view using video feeds from multiple visual input devices (e.g., cameras) of the user.

In some embodiments, the virtual meeting configuration includes instructions to associate each of the user device and the one or more additional user devices with one or more functions of a plurality of functions, wherein the plurality of functions comprises at least one of displaying at least a subset of a plurality of participants of the virtual meeting, displaying a shared screen of the virtual meeting, displaying a currently speaking participant of the virtual meeting, a camera function, a microphone function, or a speaker device function.

In some embodiments, processing logic can identify a set of characteristics for each user device of a plurality of user devices associated with the user account. The plurality of user devices can include the user device and the one or more additional user devices. The processing logic can identify, based on the sets of characteristics, a plurality of virtual meeting configurations associated with the user account. The plurality of virtual meeting configurations can include the virtual meeting configuration associated with the user account identified at block 520.

In some embodiments, processing logic provides, for presentation at the user device, the plurality of virtual meeting configurations associated with the user account, and receives, from the user device, an indication of the virtual meeting configuration associated with the user account.

In some embodiments, processing logic provides, as input to a trained AI model, the sets of characteristics. Processing logic receives, as output from the trained AI model, the plurality of virtual meeting configurations associated with the user account and a score associated with each of the plurality of meeting configurations. The score can reflect a confidence level of the corresponding virtual meeting configuration.

In some embodiments, processing logic can identify the virtual meeting configuration associated with the user account by identifying a user preference associated with the user account. The user preference can identify the virtual meeting configuration that includes the user device and at least a subset of the one or more additional user devices associated with the user account.

At block 530, processing logic identifies, based on the virtual meeting configuration associated with the user account, one or more additional user devices associated with the user account. As an illustrative example, processing logic can identify user devices 102B-C of FIG. 1 participating in a virtual meeting 120A.

At block 540, processing logic allows the user to join the virtual meeting via at least one of the one or more additional user devices associated with the user account without adding an additional visual item to the user interface of the virtual meeting.

In some embodiments, processing logic identifies a speaker device associated with each of the user device and the one or more additional user devices. Processing logic can identify a display location of a corresponding visual item for each participant of at least a subset of participants of the virtual meeting. That is, processing logic where in the UI the visual item representing each participant of at least a subset of the participants is located. For example, as illustrated in FIG. 3, processing logic can identify visual items for participants A-I as being presented on the UI of client device 320, participant N as being presented on the UI of client device 330, and participants O-Q as being presented on the UI of client device 340. Processing logic can assign a first participant of the at least subset of participants to a first speaker device of the speaker devices based on the display location of the first participant. For example, processing logic can assign participants A-I to the speaker device of device 320, can assign participant N to the speaker device of device 330, and can assign participants O-Q to the speaker device of device 340. Thus, when any of participants A-I speak, the speaker device of device 320 can output the audio from the corresponding participant A-I. When participant N speaks, the speaker device of device 330 can output the audio from participant O. When participants O-Q speak, the speaker device of device 340 can output the audio from the corresponding participant O-Q.

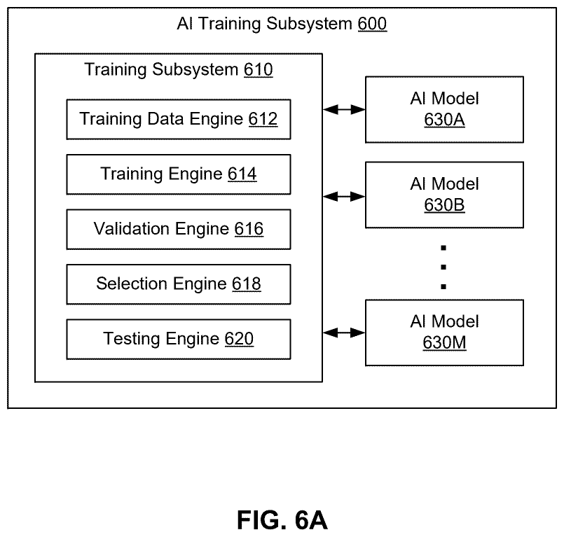

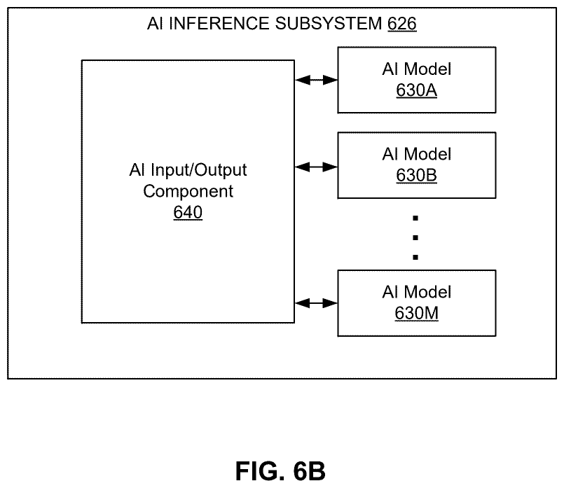

FIG. 6A illustrates a schematic block diagram for an example artificial intelligence (AI) training subsystem 600 to train one or more AI models 630A-M, in accordance with some implementations of the present disclosure. As illustrated in FIG. 6A, the AI training subsystem 600 can include a training subsystem 610, which can include a training data engine 612, a training engine 614, a validation engine 616, a selection engine 618, or a testing engine 620. The AI training subsystem 600 can include one or more AI models 630A-M.

In one implementation, an AI model 630A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN can include adjusting the weights or other features of the ANN based on an output produced by the ANN during training.

An ANN can include, for example, a convolutional neural network (CNN), recurrent neural network (RNN), or a deep neural network. A CNN, a specific type of ANN, hosts multiple layers of convolutional filters. Pooling is performed, and non-linearities can be addressed, at lower layers, on top of which a multi-layer perceptron is commonly appended, mapping top layer features extracted by the convolutional layers to decisions (e.g., classification outputs). A deep network can include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) can include a hierarchy of layers, where the different layers learn different levels of representations that correspond to different levels of abstraction. In deep learning, each level learns to transform its input data into a slightly more abstract and composite representation.

In one implementation, an AI model 630A-M includes a generative AI model 630A-M. A generative AI model 630A-M can deviate from a machine learning model based on the generative AI model's 630A-M ability to generate new, original data, rather than making predictions based on existing data patterns. A generative AI model 630A-M can include a generative adversarial network (GAN), a variational autoencoder (VAE), a large language model (LLM), or a diffusion model. In some instances, a generative AI model 630A-M can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models 630A-M also have the ability to capture and learn complex, high-dimensional structures of data. One aim of generative AI models 630A-M is to model underlying data distribution, allowing them to generate new data points that possess the same characteristics as training data. Some machine learning models (e.g., that are not generative AI models 630A-M) focus on optimizing specific prediction of tasks.

In some implementations, an AI model 630A-M is an AI model that has been trained on a corpus of data. For example, the AI model 630A-M can be an AI model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 630A-M to learn broad elements including, image or speech recognition, general sentence structure, common phrases, vocabulary, natural language structure, and other elements. In some implementations, this first foundational model is trained using self-supervision, or unsupervised training on such datasets.

In some implementations, the second portion of training, including fine-tuning, includes unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 630A-M while training can be ranked by a user, according to a variety of factors, including accuracy, helpfulness, veracity, acceptability, or any other metric useful in the fine-tuning portion of training. In this manner, the AI model 630A-M can learn to favor these and any other factors relevant to users when generating a response. Further details regarding training are provided below.

In some implementations, an AI model 630A-M includes one or more pre-trained models, or fine-tuned models. In a non-limiting example, in some implementations, the goal of the “fine-tuning” can be accomplished with a second, or third, or any number of additional models. For example, the outputs of the pre-trained model can be input into a second AI model 630A-M that has been trained in a similar manner as the “fine-tuned” portion of training above. In such a way, two more AI models 630A-M can accomplish work similar to one model that has been pre-trained, and then fine-tuned.

In some implementations, the training subsystem 610 manages the training and testing of an AI model 630A-M. The training data engine 612 can generate training data. For example, in the present disclosure the training data can include video content. The video content can include one or more video feeds of participants participating in a virtual meeting (e.g., speaking, listening, sharing, etc.). The video content can include video content of a participant sharing documents, images, etc., during a virtual meeting. Each piece of video training data can include a target output that includes a quality value of the video data of the video training data. The quality value can represent the quality of the video feed (e.g., whether the participant is visible or centered in the frame, whether the participant is in focus or out of focus in the video feed, whether the participant is facing the camera associated with a video feed, and/or other similar factors). The training engine 614 can use the video content training data to train an AI model 630A-M configured to identify a video feed to represent a user in a visual item during a virtual meeting 120A.

In some implementations, the training data can include audio data. The audio data can include data that includes a recording of a person speaking. The audio data can include one or more phonemes, word fragments, words, sentences, or other portions of speech. Each piece of audio training data can include a corresponding target output that includes a quality value of the audio data of the audio training data (e.g., whether the audio is muffled, whether there is an echo in the video feed, whether the audio is clear, and/or other similar factors). The training engine 614 can use the audio training data to train an AI model 630A-M configured to identify an audio feed to represent a user in a visual item during a virtual meeting 120A.

In some implementations, the training data can include device settings and/or device characteristics. The device settings and/or device characteristics can represent device settings provided by a user, and/or characteristics of client devices participating in a virtual meeting. Each combination of device setting and/or device characteristic can include a corresponding target output that indicates a quality value of the combination (e.g., whether each of the client device(s) is assigned an appropriate function(s)). The training engine 614 can use the device settings and/or device characteristics training data to train an AI model 630A-M configured to generate a device settings and/or device characteristics combination to use in a virtual meeting configuration for a virtual meeting 120A.

In some implementations, the training data can include video feeds from multiple client devices participating in a virtual meeting as a single participant. Each video feed can include a corresponding target output that indicates a quality value of the video (e.g., whether the participant is visible or centered in the frame, whether the participant is in focus or out of focus in the video feed, whether the participant is facing the camera associated with a video feed, and/or other similar factors). The training engine 614 can use the video feeds training data to train an AI model 630A-N configured to output an indication of which video feed(s) to use (and/or which visual input device to use) in a virtual meeting configuration for a virtual meeting.

In some implementations, the training data can include audio feeds from multiple client devices participating in a virtual meeting as a single participant. Each audio feed can include a corresponding target output that indicates a value of the audio (e.g., whether the audio is muffled, whether there is an echo in the video feed, whether the audio is clear, and/or other similar factors). The training engine 614 can use the audio feeds training data to train an AI model 630A-N configured to output an indication of which audio feed(s) to use (and/or which audio input device to use) in a virtual meeting configuration for a virtual meeting.

In some implementations, the training data can include audio feeds from multiple client devices of other participants participating in a virtual meeting. Each combination of the audio feeds can include a corresponding target output that indicates a value of the combination. The training engine 614 can use the audio feeds training data to train an AI model 630A-N configured to output an indication of a combination of audio feeds to use for outputting audio during a virtual meeting.

In some implementations, the training data can include video feeds from multiple visual input devices (e.g., cameras) of client devices participating in a virtual meeting as a single participant. The client devices can include a multi-camera setup and depth sensors. The training engine 614 can use the video feeds training data to train an AI model 630A-N configured to output a 360-degree representation of the user participating in the virtual meeting.

In an illustrative example, the training data engine 612 can initialize a training set T to null (e.g., { }). The training data engine 612 can add the training data to the training set T and can determine whether training set T is sufficient for training a AI model 630A-M. The training set T can be sufficient for training the AI model 630A-M if the training set T includes a threshold amount of training data, in some implementations. In response to determining that the training set T is not sufficient for training, the training data engine 612 can identify additional data to use as training data. In response to determining that the training set T is sufficient for training, the training data engine 612 can provide the training set T to the training engine 614.

The training engine 614 can train an AI model 630A-M using the training data (e.g., training set T). The AI model 630A-M can refer to the model artifact that is created by the training engine 614 using the training data, where such training data can include training inputs and, in some implementations, corresponding target outputs. The training engine 614 can input the training data into the AI model 630A-M so that the AI model 630A-M can find patterns in the training data and configure itself based on those patterns.

Where the AI model 630A-M uses supervised learning, the training engine 614 can assist the AI model 630A-M in determining whether the AI model 630A-M maps the training input to the target output. Where the AI model 630A-M uses unsupervised learning, the training engine 614 can input the training data into the AI model 630A-M The AI model 630A-M can configure itself based on the input training data, but since the training data may not include a target output, the training engine 614 may not assist the AI model 630A-M in determining whether the AI model 630A-M provided a correct output during the training process.

The validation engine 616 can be capable of validating a trained AI model 630A-M using a corresponding set of features of a validation set from the training data engine 612. The validation engine 616 can determine an accuracy of each of the trained AI models 630A-M based on the corresponding sets of features of the validation set. Where the training data may not include a target output, validating a trained AI model 630A-M can include obtaining an output from the AI model 630A-M and providing the output to another entity for evaluation. The other entity can include another AI model 630A-M configured to evaluate the output of the AI model 630A-M that is undergoing training. The other entity can include a human. The validation engine 616 can discard a trained AI model 630A-M that has an accuracy that does not meet a threshold accuracy or that otherwise fails evaluation. In some implementations, the selection engine 618 is capable of selecting a trained AI model 630A-M that has an accuracy that meets a threshold accuracy. In some implementations, the selection engine 618 can be capable of selecting the trained AI model 630A-M that has the highest accuracy of multiple trained AI models 630A-M. In some implementations, the selection engine 618 receives input from another AI model 630A-M or a human and can select a trained AI model 630A-M based on the input.

The testing engine 620 can be capable of testing a trained AI model 630A-M using a corresponding set of features of a testing set from the training data engine 612. For example, a first trained AI model 630A that was trained using a first set of features of the training set can be tested using the first set of features of the testing set. The testing engine 620 can determine a trained AI model 630A-M that has the highest accuracy or other evaluation of all of the trained AI models 630A-M based on the testing sets.

In some implementations, the training engine 614 trains an AI model 630A. The AI model 630A can generate a virtual meeting configuration for a participant of virtual meeting 120A. The training data engine 612 can generate training data that includes one or more virtual meeting configurations, and the training engine 614 can cause the AI model 630A to undergo an AI model training process using the training data. The AI model 630A can undergo a validation and testing process using the validation engine 616 and testing engine 620.

In some implementations, the training engine 614 trains an I model 630B. The AI model 630B can identify a virtual meeting configuration for a participant of virtual meeting 120A. The training data engine 612 can generate training data that includes one or more virtual meeting configurations, and the training engine 614 can cause the AI model 630A to undergo an AI model training process using the training data. The AI model 630A can undergo a validation and testing process using the validation engine 616 and testing engine 620.

In some implementations, the training engine 614 trains an AI model 630C. The AI model 630C can identify one or more visual input device(s) (e.g., cameras) to use in a virtual meeting configuration for a participant of virtual meeting 120A. The training data engine 612 can generate training data that includes one or more identifications of a visual input source(s), and the training engine 614 can cause the AI model 630A to undergo an AI model training process using the training data. The AI model 630A can undergo a validation and testing process using the validation engine 616 and testing engine 620.

In some implementations, the training engine 614 can train an AI model 630D. The AI model 630D can identify one or more audio input device(s) (e.g., microphones) to use in a virtual meeting configuration for a participant of virtual meeting 120A. The training data engine 612 can generate training data that includes one or more identifications of an audio input source(s), and the training engine 614 can cause the AI model 630A to undergo an AI model training process using the training data. The AI model 630A can undergo a validation and testing process using the validation engine 616 and testing engine 620.

In some implementations, the training engine 614 can train an AI model 630E. The AI model 630E can identify an audio output device configuration (e.g., a speaker configuration) to use in a virtual meeting configuration for a participant of virtual meeting 120A. In some embodiments, the audio output device configuration can be a three-dimensional configuration. The training data engine 612 can generate training data that includes one or more identifications of an audio output device configurations, and the training engine 614 can cause the AI model 630A to undergo an AI model training process using the training data. The AI model 630A can undergo a validation and testing process using the validation engine 616 and testing engine 620.

In some implementations, the training engine 614 can train an AI model 630F. The AI model 630F can generate a 360-degree view of the participant using three or more visual input devices (e.g., cameras), during a virtual meeting 120A. The training data engine 612 can generate training data that includes one or more 360-degree views of users from three or more video feeds, and the training engine 614 can cause the AI model 630A to undergo an AI model training process using the training data. The AI model 630A can undergo a validation and testing process using the validation engine 616 and testing engine 620.

In some implementations, the AI training subsystem 600 is part of the server 130, the platform 120, or the virtual meeting manager 122. Alternatively, the AI training subsystem 600 can be part of another server, system, sub-system, or it can be an independent system. In some implementations, the AI training subsystem 600 provides the trained one or more AI models 630A-M to the virtual meeting manager 122.

FIG. 6B illustrates a schematic block diagram for an AI inference subsystem 626 of a virtual meeting platform 120, that the configuration component 226 can use to perform one or more operations, in accordance with at least one embodiment of the present disclosure. The AI inference subsystem 626 can include one or more AI models 630A-M. The one or more AI models 630A-M can include one or more of the AI models 630A-M trained by the AI training subsystem 600, as described with respect to FIG. 6A.

In some implementations, the AI inference subsystem 626 includes an AI input/output component 640. The AI input/output component 640 can be configured to feed data as input to an AI model 630A-M, e.g., one or more video feeds received from client devices 102A-N, one or more audio feeds received from client devices 102A-N, device settings 212, device characteristics 214, and/or configuration 216. The AI input/output component 640 can be configured to obtain one or more outputs from the one or more AI models 630A-M and provide the one or more outputs to the configuration component 226.

In some implementations, an AI model 630A-M includes an LLM. In some embodiments, the LLM includes generative AI functionality. In some embodiments, an AI model 630A-N includes image, video, and/or audio-based generative AI functionality. The AI model 630A-M can generate new content based on provided input data (e.g., video and/or audio feeds from client devices during the virtual meeting 120A). The generative AI model 630A-M can be supported by a prompt subsystem (not shown), which can reside on the system architecture 100. The prompt subsystem can enable a user or a component of the system architecture 100 to access the generative AI model 630A-M. The prompt subsystem can be configured to perform automated identification of, and facilitate retrieval of, relevant and timely contextual information for efficient and accurate processing of prompts by the AI model 630A-M. Using the network 150 (or another network), the prompt subsystem can be in communication with one or more of the virtual meeting manager 122. Communications between the prompt subsystem and the AI input/output component 640 can be facilitated by a generative model application programming interface (API), in some embodiments. Communications between the prompt subsystem and the virtual meeting manager 122 can be facilitated by a data management API. In additional or alternative embodiments, the generative model API translates prompts generated by the prompt subsystem into an unstructured natural-language format and, conversely, translates responses received from the AI model 630A-M into any suitable form (e.g., including any structured proprietary format as can be used by the prompt subsystem). Similarly, the data management API can support instructions that can be used to communicate data requests to the virtual meeting manager 122 and formats of data received from such components.

The prompt subsystem can include (or can have access to) instructions stored on one or more tangible, machine-readable storage media of a computing device (e.g., the server 130) and executable by one or more processing devices of the computing device. In one embodiment, the prompt subsystem can be implemented on a single machine. In some embodiments, the prompt subsystem can be a combination of a client component and a server component. Alternatively, some portion of the prompt subsystem can be executed on a client computing device while another portion of the query tool can be executed on a server machine.

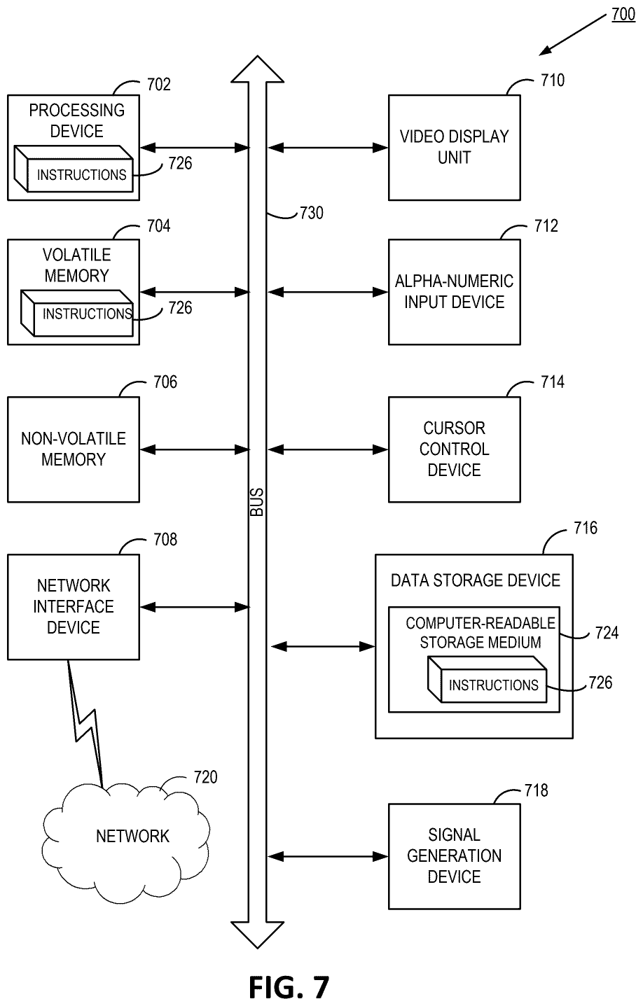

FIG. 7 is a block diagram illustrating an exemplary computer system 700, in accordance with at least one embodiment of the present disclosure. The computer system 700 can correspond to server device 130, platform 120, and/or user devices 102A-N in FIG. 1. The machine can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., volatile memory, read-only memory (ROM), flash memory, dynamic random access memory (DRAM) such as synchronous DRAM (SDRAM), double data rate (DDR SDRAM), or DRAM (RDRAM), etc.), a static memory 706 (e.g., non-volatile memory, flash memory, static random access memory (SRAM), etc.), and a data storage device 716, which communicate with each other via a bus 730.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 726 (e.g., for providing a multi-device user experience for virtual meetings) for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a non-transitory machine-readable storage medium 724 (also computer-readable storage medium) on which is stored one or more sets of instructions 726 (e.g., for providing a multi-device user experience for virtual meetings) embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 720 via the network interface device 708.

In one implementation, the instructions 726 include instructions for providing a multi-device user experience for virtual meetings. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
identifying a user device participating in a virtual meeting, wherein the user device is associated with a user account of a user, and wherein a user interface of the virtual meeting comprises a visual item representing the user;
identifying a virtual meeting configuration associated with the user account;
identifying, based on the virtual meeting configuration associated with the user account, one or more additional user devices associated with the user account; and
allowing the user to join the virtual meeting via at least one of the one or more additional user devices associated with the user account without adding an additional visual item to the user interface of the virtual meeting.

2. The method of claim 1, further comprising:
identifying a set of characteristics for each user device of a plurality of user devices associated with the user account, wherein the plurality of user devices comprises the user device and the one or more additional user devices; and
identifying, based on the sets of characteristics, a plurality of virtual meeting configurations associating with the user account, wherein the plurality of virtual meeting configurations associated with the user account comprises the virtual meeting configuration associated with the user account.

3. The method of claim 2, further comprising:
providing, for presentation at the user device, the plurality of virtual meeting configurations associated with the user account; and
receiving, from the user device, an indication of the virtual meeting configuration associated with the user account.

4. The method of claim 2, wherein identifying, based on the sets of characteristics, the plurality of virtual meeting configurations associated with the user account comprises:
providing, as input to a trained artificial intelligence (AI) model, the sets of characteristics; and
receiving, as output from the trained AI model, the plurality of virtual meeting configurations associated with the user account and a score associated with each of the plurality of virtual meeting configurations, wherein the score reflects a confidence level of the corresponding virtual meeting configuration.

5. The method of claim 1, wherein identifying the virtual meeting configuration associated with the user account comprises:
identifying a user preference associated with the user account, wherein the user preference identifies the virtual meeting configuration comprising the user device and the at least one of the one or more additional user devices associated with the user account.

6. The method of claim 1, wherein the virtual meeting configuration comprises at least one of:
a three-dimensional visual configuration;
a three-dimensional audio configuration; or
a 360-degree representation of the user generated using artificial intelligence based on visual input from the user device and at least two additional user devices.

7. The method of claim 1, wherein the virtual meeting configuration comprises associating each of the user device and the one or more additional user devices with one or more functions of a plurality of functions, wherein the plurality of functions comprises at least one of: displaying at least a subset of a plurality of participants of the virtual meeting, displaying a shared screen of the virtual meeting, displaying a currently speaking participant of the virtual meeting, a camera function, a microphone function, or a speaker device function.

8. The method of claim 1, further comprising:
identifying a speaker device associated with each of the user device and the one or more additional user devices;
identifying a display location of a corresponding visual item for each participant of at least a subset of participants of the virtual meeting; and
assigning a first participant of the at least the subset of the participants to a first speaker device of the speaker devices based on the display location of the first participant.

9. A system comprising:
a memory device; and
a processing device coupled to the memory device, the processing device to perform operations comprising:
identifying a user device participating in a virtual meeting, wherein the user device is associated with a user account of a user, and wherein a user interface of the virtual meeting comprises a visual item representing the user;
identifying a virtual meeting configuration associated with the user account;
identifying, based on the virtual meeting configuration associated with the user account, one or more additional user devices associated with the user account; and
allowing the user to join the virtual meeting via at least one of the one or more additional user devices associated with the user account without adding an additional visual item to the user interface of the virtual meeting.

10. The system of claim 9, further comprising:
identifying a set of characteristics for each user device of a plurality of user devices associated with the user account, wherein the plurality of user devices comprises the user device and the one or more additional user devices; and
identifying, based on the sets of characteristics, a plurality of virtual meeting configurations associated with the user account, wherein the plurality of virtual meeting configurations associated with the user account comprises the virtual meeting configuration associated with the user account.

11. The system of claim 10, further comprising:
providing, for presentation at the user device, the plurality of virtual meeting configurations associated with the user account; and
receiving, from the user device, an indication of the virtual meeting configuration associated with the user account.

12. The system of claim 10, wherein identifying based on the sets of characteristics, the plurality of virtual meeting configurations associated with the user account comprises:
providing, as input to a trained artificial intelligence (AI) model, the sets of characteristics; and
receiving, as output from the trained AI model, the plurality of virtual meeting configurations associated with the user account and a score associated with each of the plurality of virtual meeting configurations, wherein the score reflects a confidence level of the corresponding virtual meeting configuration.

13. The system of claim 9, wherein identifying the virtual meeting configuration associated with the user account comprises:
identifying a user preference associated with the user account, wherein the user preference identifies the virtual meeting configuration comprising the user device and the at least one of the one or more additional user devices associated with the user account.

14. The system of claim 9, wherein the virtual meeting configuration comprises at least one of:
a three-dimensional visual configuration;
a three-dimensional audio configuration; or
a 360-degree representation of the user generated using artificial intelligence based on visual input from the user device and at least two additional user devices.

15. The system of claim 9, wherein the virtual meeting configuration comprises associating each of the user device and the one or more additional user devices with one or more functions of a plurality of functions, wherein the plurality of functions comprises at least one of: displaying at least a subset of a plurality of participants of the virtual meeting, displaying a shared screen of the virtual meeting, displaying a currently speaking participant of the virtual meeting, a camera function, a microphone function, or a speaker device function.

16. The system of claim 9, further comprising:
identifying a speaker device associated with each of the user device and the one or more additional user devices;
identifying a display location of a corresponding visual item of each participant of at least a subset of participants of the virtual meeting; and
assigning a first participant of the at least the subset of the participants to a first speaker device of the speaker devices based on the display location of the first participant.

17. A non-transitory computer readable storage medium comprising instructions for a server that, when executed by a processing device, cause the processing device to perform operations comprising:
identifying a user device participating in a virtual meeting, wherein the user device is associated with a user account of a user, and wherein a user interface of the virtual meeting comprises a visual item representing the user;
identifying a virtual meeting configuration associated with the user account;
identifying, based on the virtual meeting configuration associated with the user account, one or more additional user devices associated with the user account; and
allowing the user to join the virtual meeting via at least one of the one or more additional user devices associated with the user account without adding an additional visual item to the user interface of the virtual meeting.

18. The non-transitory computer readable storage medium of claim 17, further comprising:
identifying a set of characteristics for each user device of a plurality of user devices associated with the user account, wherein the plurality of user devices comprises the user device and the one or more additional user devices;
providing, as input to a trained artificial intelligence (AI) model, the sets of characteristics; and
receiving, as output from the trained AI model, a plurality of virtual meeting configurations associated with the user account and a score associated with each of the plurality of virtual meeting configurations, wherein the score reflects a confidence level of the corresponding virtual meeting configuration.

19. The non-transitory computer readable storage medium of claim 17, wherein identifying the virtual meeting configuration associated with the user account comprises:
identifying a user preference associated with the user account, wherein the user preference identifies the virtual meeting configuration comprising the user device and the at least one of the one or more additional user devices associated with the user account.

20. The non-transitory computer readable storage medium of claim 17, wherein the virtual meeting configuration comprises associating each of the user device and the one or more additional user devices with one or more functions of a plurality of functions, wherein the plurality of functions comprises at least one of: displaying at least a subset of a plurality of participants of the virtual meeting, displaying a shared screen of the virtual meeting, displaying a currently speaking participant of the virtual meeting, a camera function, a microphone function, or a speaker device function.
